(19) United States
(12) Patent Application Publication
(10) Pub. No.: US 2009/0054614 A1
(43) Pub. Date: Feb. 26, 2009

(54) METHOD FOR PRODUCING THERMOSETTING RESIN, THERMOSETTING RESIN, THERMOSETTING COMPOSITION CONTAINING SAME, MOLDED BODY, CURED BODY, AND ELECTRONIC DEVICE CONTAINING THOSE

(75) Inventors: Yuji Eguchi, Ibaraki (JP); Kazuo Doyama, Ibaraki (JP); Hatsuo Ishida, Ibaraki (JP)

Correspondence Address: SUGHRUE MION, PLLC, 2100 PENNSYLVANIA AVENUE, N.W., SUITE 800, WASHINGTON, DC, 20037, US

(73) Assignee: SEKISUI CHEMICAL CO., LTD., Osaka-shi, Osaka (JP)

(21) Appl. No.: 12/280,029

(22) PCT Filed: Feb. 20, 2007
(86) PCT No.: PCT/JP2007/053044

§ 371 Date: Aug. 20, 2008

(30) Foreign Application Priority Data
Feb. 20, 2006 (JP) 2006-043028

(51) Int. Cl. C08G 14/073

(52) U.S. Cl. 528/162

(57) ABSTRACT

The present invention provides a method for producing a thermosetting resin having a dihydrobenzoxazine ring structure, characterized by heating and reacting a) a multi-functional phenolic compound represented by the following general formula (I), b) a diamine compound represented by the following general formula (II) and c) an aldehyde compound:

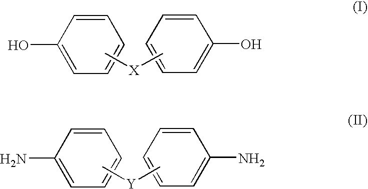

wherein X is an organic group containing an aromatic ring and having 6 or more carbon atoms, Y is an organic group having 5 or more carbon atoms, while both X and Y optionally have N, O, F as a heteroatom, and the benzene rings of both sides of X and Y are bonded to different atoms in X and Y.

### TECHNICAL FIELD

The present invention relates to a method for producing a thermosetting resin which is excellent in heat resistance and good in electrical properties thus to be greatly improved in brittleness, a thermosetting resin produced by the method, a thermosetting composition containing the same, a molded body thereof, a cured body thereof, and an electronic device containing those.

### BACKGROUND ART

Previously, thermosetting resins such as phenolic resins, melamine resins, epoxy resins, unsaturated polyester resins, bismaleimide resins and the like have been used in the wide ranges of industrial fields because of their excellent water resistance, chemical resistance, heat resistance, mechanical strength, reliability and the like based on their thermosetting property.

However, there have been disadvantages that the phenolic resins and melamine resins produce volatile by-products upon curing, the epoxy resins and unsaturated polyester resins are inferior in flame resistance, the bismaleimide resins are very expensive, and so on.

In order to resolve such disadvantages, there has been carried out studies on dihydrobenzoxazine compounds (hereinafter, can also be referred to as “benzoxazine compounds”) which are thermally cured without causing the production of volatiles which are likely to be a problem. The benzoxazine compounds are a resin having many advantages that those are excellent in preservability, have relatively low viscosity upon dissolving and wide degree of freedom in molecular design, and the like, in addition to the basic properties of the thermosetting resins as mentioned above. Such benzoxazine compounds are disclosed, for example, in Japanese Patent Application Laid-Open Publication No. S49-47378 (Patent Document 1) and the like. In addition, with respect to high densification (miniaturization) of electronic devices-elements and high speed of signal transfer, it has been requested to improve the speed of signal transfer or high-frequency properties by enhancing dielectric properties (lowering dielectric constant and dielectric loss).

As a raw material for thermosetting resins having such excellent dielectric properties, dihydrobenzoxazine compounds represented by the following formula (1) or formula (2) have been known (for example, refer to Non-Patent Documents 1 and 2):

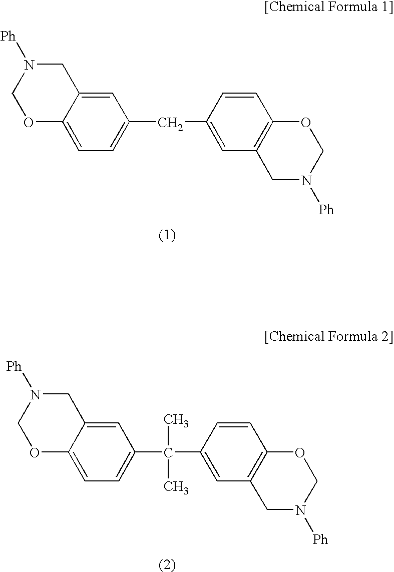

Resins obtained by a ring-opening polymerization of the benzoxazine ring of the dihydrobenzoxazine compounds are not accompanied with the production of volatiles upon curing and are excellent in flame resistance and water resistance as well.

However, although the dihydrobenzoxazine compounds in the prior art are excellent in dielectric properties among thermosetting resins as mentioned above, higher dielectric properties have been requested according to higher performance of electronic devices elements recently. For example, as for resin materials for a multilayered substrate forming IC packages of memory or logic processors and the like, it has been requested that a dielectric constant as a property at 100 MHz and 1 GHz at an environmental temperature of 23° C. is 3.5 or lower and a dielectric loss at the same conditions is 0.015 or lower as a value of a dielectric tangent which is a measure of a dielectric loss.

From the aspect of a technical trend expected from now on, it tends to request much lower dielectric loss. That is, because a dielectric loss tends to be generally proportional to frequency and a dielectric tangent of a material while frequency used in electronic devices elements tends to be higher, the request for materials having a lower dielectric tangent has been more increased. Moreover, as for the requests for improving electrical properties and heat resistance or imparting strength and flexibility, a technique for responding by micro-processing is suggested in Japanese Patent Application Laid-Open Publication No. 2005-239827 (Patent Document 2). Meanwhile, this technique involves an existence of a free —OH group and thus is disadvantageous in the aspect of a moisture-absorbing property and electrical properties. Japanese Patent Application Laid-Open Publication No. 2003-64180 (Patent Document 3) discloses thermosetting resins having a benzoxazine structure in the main chain which are excellent in heat resistance and mechanical properties, and among those, ones that bifunctional phenolic moiety therein is bonded with siloxane group are disclosed.

In said Document, a long chain aromatic diamine is disclosed as one to impart flexibility, however, as a result of the inventors of the present invention, it turned out that flexibility is not sufficient in a combination of the description of said Document. It becomes disadvantageous in the aspect of electrical properties to contain high polar groups such as a sulfone group.

Also, Non-Patent Document 3 and Patent Document 4 disclose benzoxazine compounds of specific structures which have a benzoxazine structure in the main chain. However, Non-Patent Document 3 discloses only such compounds and there are no descriptions on evaluation of properties. Patent Document 4 does not disclose instructions or compounds for improving heat resistance or imparting flexibility. Moreover, Non-Patent Document 4 discloses a mechanism for decomposing a cured body of benzoxazine compounds. Aniline and mono-functional cresol disclosed in the Documents are volatile at low temperature. Patent Document 5 discloses a method for preparing benzoxazine compounds in which both diamine and monoamine are essential as amine. However, the use of monoamine is disadvantageous in the aspect of heat resistance.

Patent Document 1: Japanese Patent Application Laid-Open Publication No. S49-47378

Patent Document 2: Japanese Patent Application Laid-Open Publication No. 2005-239827

Patent Document 3: Japanese Patent Application Laid-Open Publication No. 2003-64180

Patent Document 4: Japanese Patent Application Laid-Open Publication No. 2002-338648

Patent Document 5: Japanese Patent Publication No. 3550814 Non-Patent Document 1: Homepage of KONISHI CHEMICAL IND. CO., LTD. (found on Nov. 24, 2005), Internet <URL:http://www.konishi/chem.co.jp/cgi/data/jp/pdf/pdf_{—}2.pdf>

Non-Patent Document 2: Homepage of SHIKOKU CHEMICAL INDUSTRIES, Ltd. (found on Nov. 24, 2005), Internet

<URL:http://www.shikoku.co.jp/products/benzo.Html>

Non-Patent Document 3: “Benzoxazine Monomers and polymers: New phenolic Resins by Ring-Opening Polymerization,” J. P. Liu and H. Ishida, “The Polymeric Materials Encyclopedia,” J. C. Salamone, Ed., CRC Press, Florida (1996) pp. 484-494

Non-Patent Document 4: H. Y. Low and H. Ishida, Polymer, 40. 4365 (1999)

### DISCLOSURE OF THE INVENTION

### Problems to be Solved by the Invention

Therefore, it is an object of the present invention to provide to a method for producing a thermosetting resin which is excellent in heat resistance, good in electrical properties and greatly improved in brittleness and a thermosetting resin produced by the method.

Further, it is another object of the present invention to provide a thermosetting composition containing said thermosetting resin, a molded body thereof, a cured body thereof, and an electronic device containing those.

### Means for Solving the Problems

From the results of careful studies, the present inventors obtained the knowledge that the objects can be achieved by a method for producing a thermosetting resin using a specific aromatic diamine and a specific phenolic compound without using an aliphatic amine and an aromatic monoamine, from the point of view of improving heat resistance. The present invention is based on such knowledge. That is, the constitution of the present invention is as described below.

Hereinafter, “benzoxazine resin” refers to the above-mentioned resin having a dihydrobenzoxazine ring structure.

1. A method for producing a thermosetting resin having a dihydrobenzoxazine ring structure, characterized by heating and reacting a) a multi-functional phenolic compound represented by the following general formula (I), b) a diamine compound represented by the following general formula (II) and c) an aldehyde compound:

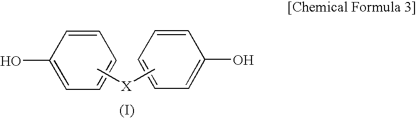

wherein X is an organic group containing an aromatic ring and having 6 or more carbon atoms, which optionally has N, O, F as a heteroatom, provided that the benzene rings of both sides of X are bonded to different atoms in X;

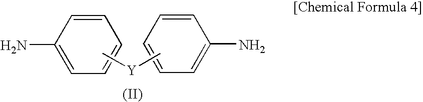

wherein Y is an organic group having 5 or more carbon atoms which optionally has N, O, F as a heteroatom, provided that the benzene rings of both sides of Y are bonded to different atoms in Y.

2. The method for producing a thermosetting resin according to the above 1, wherein X in the general formula (I) is bonded at a para-position with respect to each —OH group in the benzene rings of both sides of X and the structure of X is one of the following structures:

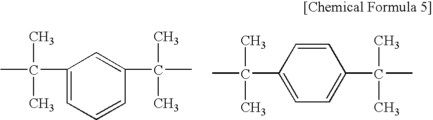

3. The method for producing a thermosetting resin according to the above 1 wherein X in the general formula (I) is a structure represented by the following structure:

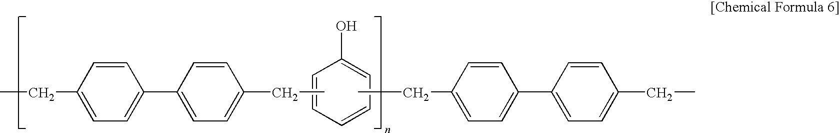

wherein n represents an integer of from 0 to 10.

4. The method for producing a thermosetting resin according to the above 1, wherein X in the general formula (I) is a structure of the following formula:

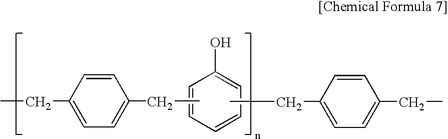

wherein n represents an integer of from 0 to 10.

5. The method for producing a thermosetting resin according to the above 1, wherein X in the general formula (I) is a structure represented by the following formula:

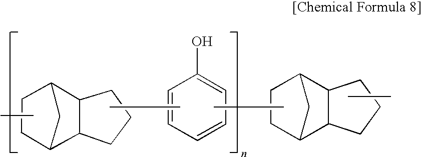

wherein n represents an integer of from 0 to 10.

6. The method for producing a thermosetting resin having a dihydrobenzoxazine ring structure according to the above 1, characterized by heating and reacting a) a multi-functional phenolic compound represented by the following general formula (I), b) a diamine compound represented by the following general formula (II), c) an aldehyde compound and d) a mono-functional phenolic compound represented by the following general formula (III):

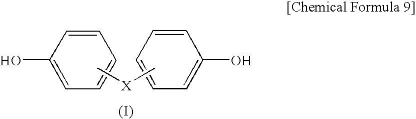

wherein X is an organic group containing an aromatic ring and having 6 or more carbon atoms, which optionally has N, O, F as a heteroatom, provided that the benzene rings of both sides of X are bonded to different atoms in X;

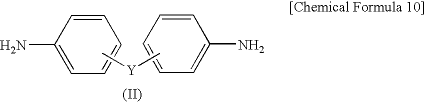

wherein Y is an organic group having 5 or more carbon atoms which optionally has N, O, F as a heteroatom, provided that the benzene rings of both sides of Y are bonded to different atoms in Y:

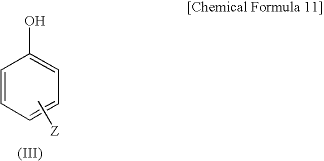

wherein Z is an organic group having 4 or more carbon atoms which optionally has N, O, F as a heteroatom.

7. The method for producing a thermosetting resin according to the above 6, wherein the substituent Z in the—functional phenolic compound represented by the general formula (III) is bonded at a para-position with respect to —OH group and is a group represented by the following formula:

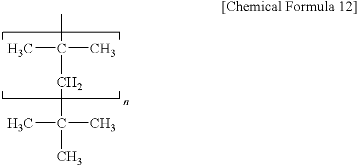

wherein n represents an integer of from 0 to 10.

8. The method for producing a thermosetting resin according to the above 6, wherein the substituent Z in the—functional phenolic compound represented by the general formula (III) is bonded at a para-position with respect to —OH group and is a group represented by the following formula:

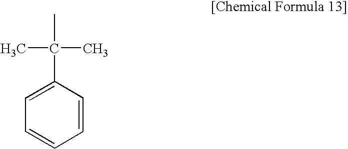

9. The method for producing a thermosetting resin according to the above 1 wherein Y in the general formula (II) is a group represented by the following formula:

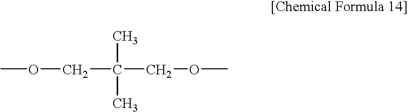

10. The method for producing a thermosetting resin according to the above 1, wherein Y in the general formula (II) contains one benzene ring.

11. The method for producing a thermosetting resin according to the above 10, wherein Y in the general formula (II) is at least one group selected from the group consisting of the following formulae and is bonded at a meta-position or para-position with respect to each NH₂ group in the benzene rings bonded to both sides of Y:

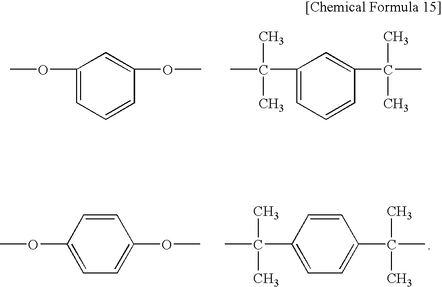

12. The method for producing a thermosetting resin according to the above 1, wherein Y in the general formula (II) contains at least 2 benzene rings.

13. The method for producing a thermosetting resin according to the above 12, wherein Y in the general formula (II) is at least one group selected from the group consisting of the following formulae and is bonded at a meta-position or para-position with respect to each NH₂ group in the benzene rings bonded to both sides of Y:

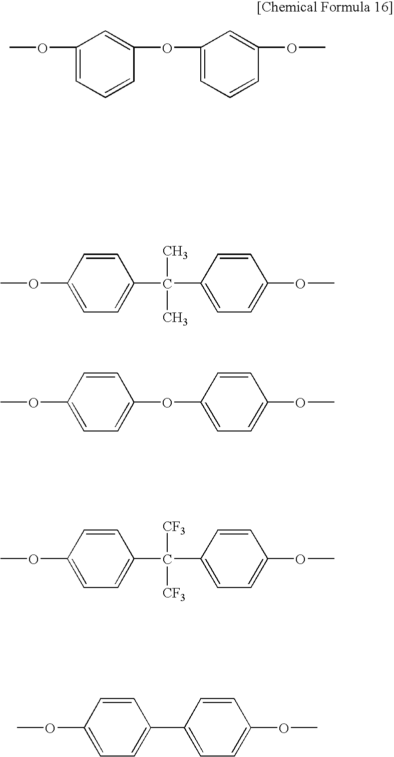

14. A thermosetting resin characterized by having a dihydrobenzoxazine structure represented by the following general formula (IV):

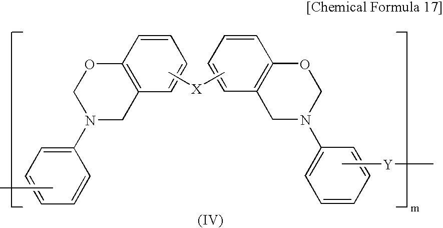

wherein X is an organic group containing an aromatic ring and having 6 or more carbon atoms, which optionally has N, O, F as a heteroatom, provided that the benzene rings of both sides of X are bonded to different atoms in X; Y is an organic group having 5 or more carbon atoms which optionally has N, O, F as a heteroatom, provided that the benzene rings of both sides of Y are bonded to different atoms in Y; and m represents an integer of from 1 to 50.

15. The thermosetting resin according to the above 14, wherein X in the general formula (IV) has a structure of one of the following X: group, and Y in the general formula (IV) has a structure of one of the following Y: group:

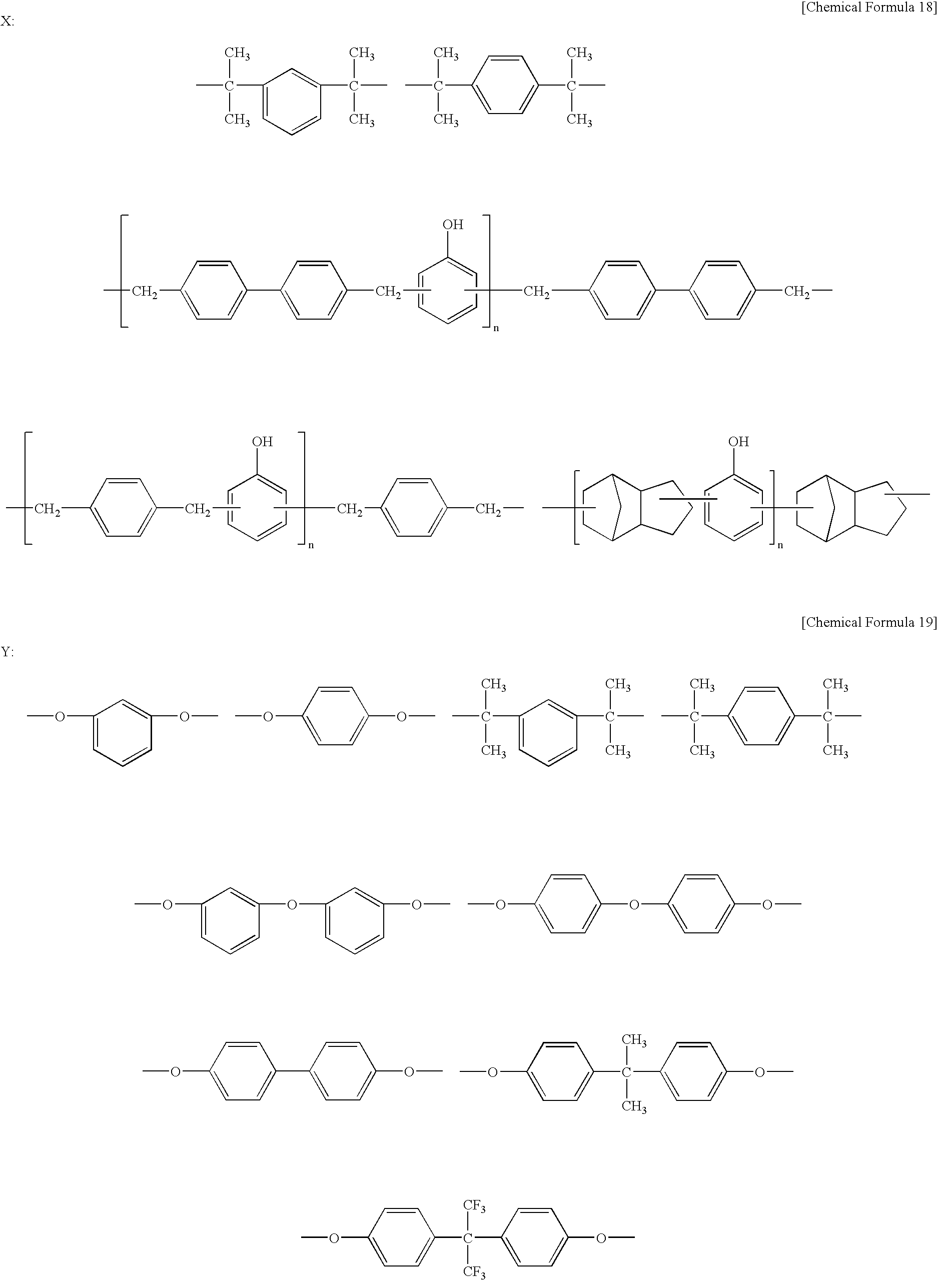

16. A thermosetting composition containing at least the thermosetting resin according to the above 14.

17. A molded body obtained by semi-curing or without curing the thermosetting composition according to the above 16.

18. A cured body obtained from the thermosetting resin according to the above 14.

19. A cured body obtained from the thermosetting composition according to the above 16.

20. An electronic element containing the cured body according to the above 18 or 19.

21. A thermosetting resin produced by the method according to the above 1.

22. A thermosetting composition containing at least the thermosetting resin according to the above 21.

23. A molded body obtained by semi-curing or without curing the thermosetting composition according to the above 22.

24. A cured body obtained from the thermosetting resin according to the above 21.

25. A cured body obtained from the thermosetting composition according to the above 22.

26. An electronic element containing the cured body according to the above 24 or 25.

### ADVANTAGE OF THE INVENTION

According to the present invention, there are provided a method for producing a thermosetting resin which is excellent in heat resistance, good in electrical properties and greatly improved in brittleness, a thermosetting resin produced by the method, a thermosetting composition containing the resin, a molded body thereof, a cured body thereof, and an electronic device containing those.

### BEST MODE FOR CARRYING OUT THE INVENTION

Hereinafter, the present invention will be described in detail with respect to preferred exemplary embodiments of the invention.

### [A Method for Producing a Thermosetting Resin]

A method for producing a thermosetting resin according to the present invention is characterized by heating and reacting a) a multi-functional phenolic compound represented by the following general formula (I), b) a diamine compound represented by the following general formula (II) and c) an aldehyde compound. According to the production method of the present invention, a thermosetting resin having a dihydrobenzoxazine ring structure can be obtained. The obtained thermosetting resin is excellent in heat resistance, good in electrical properties, and greatly improved in brittleness:

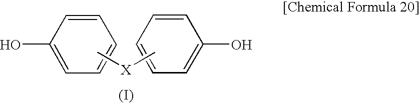

wherein X is an organic group containing an aromatic ring and having 6 or more carbon atoms, which optionally has N, O, F as a heteroatom, provided that the benzene rings of both sides of X are bonded to different atoms in X;

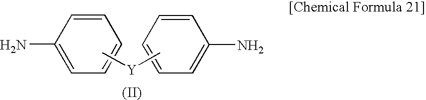

wherein Y is an organic group having 5 or more carbon atoms which optionally has N, O, F as a heteroatom, provided that the benzene rings of both sides of Y are bonded to different atoms in Y.

In the present invention, a multi-functional phenolic compound represented by the above general formula (I) is used as the ingredient a). Such multi-functional phenolic compound is not particularly limited as long as it is a multi-functional phenol being bifunctional or more. This multi-functional phenol being bifunctional or more is used individually or in combination of two or more thereof.

In the multi-functional phenolic compound used as the component a) in present invention, X is an organic group containing an aromatic ring and having 6 or more, preferably 8 or more, more preferably 12 to 21 carbon atoms. X optionally has N, O, F as a heteroatom.

Particularly, from the aspect of reactivity in the synthesis of the thermosetting resin, and heat resistance, mechanical properties and electrical properties of a cured body, it is preferable that X is bonded at a para-position with respect to each —OH group in the benzene rings of both sides of X and that the structure of X is one or all of the following structures:

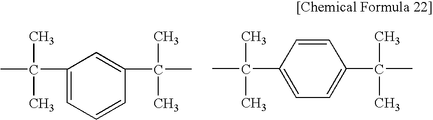

It is particularly preferred that X has a structure represented by the following formula from the aspect of reactivity in the synthesis of the thermosetting resin, and heat resistance, mechanical properties and electrical properties of a cured body:

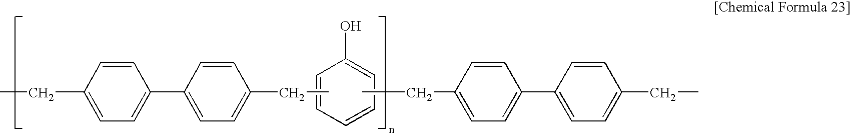

wherein n represents an integer of from 0 to 10, preferably from 0 to 5.

Further, it is also particularly preferred that X has a structure represented by the following formula from the aspect of reactivity in the synthesis of the thermosetting resin, and heat resistance, mechanical properties and electrical properties of a cured body:

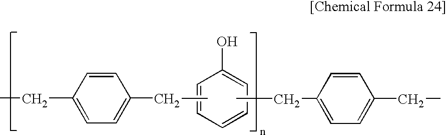

wherein n represents an integer of from 0 to 10, preferably from 0 to 5.

Moreover, it is also particularly preferred that X has a structure represented by the following formula from the aspect of reactivity in the synthesis of the thermosetting resin, and heat resistance, mechanical properties and electrical properties of a cured body:

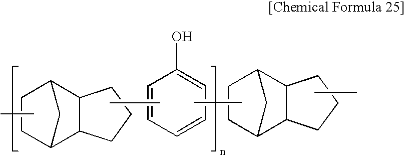

wherein n represents an integer of from 0 to 10.

Specific examples for the multi-functional phenolic compound as such ingredient a) may include 4,4′-[1,4-phenylene-bis(1-methylethylidene)]bisphenol Bisphenol P, manufactured by Mitsui Chemicals), 4,4′-[1,3-phenylene-bis(1-methylethylidene)]bisphenol (Bisphenol M, manufactured by Mitsui Chemicals), biphenylnovolac-type phenolic resins (MEH7851, manufactured by Meiwa Chemical Co., Ltd.), xylene novolac-type resins (MEH7800, manufactured by Meiwa Chemical Co., Ltd.), and the like. These multi-functional phenolic compounds are used individually or in a combination of two or more thereof.

In the present invention, a diamine compound represented by the above general formula (II) is used as the ingredient b). Such diamine compound is essential from the aspect of improving flexibility.

Said diamine compound used as the ingredient b) in the present invention is a long-chain aromatic diamine compound, and Y in the general formula (II)) is an organic group having 5 or more, preferably 5 to 20, more preferably 5 to 15 carbon atoms. Moreover, Y optionally has N, O, F as a heteroatom to improve electrical properties. Further, the benzene rings of both sides of Y are not bonded to the same atom in Y.

It is preferable that Y is a group represented by the following formula, particularly from the aspects of solubility in the synthesis of a thermosetting resin, and mechanical properties and electrical properties of a cured body:

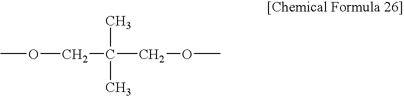

It is preferable that Y contains one benzene ring particularly from the aspects of heat resistance, mechanical properties and electrical properties of a cured body.

Specific examples for Y containing one benzene ring may include at least one group selected from the group of the following formulae and bonded at a meta-position or para-position with respect to each NH₂ group in the benzene rings bonded to both sides of Y, and the like. It is preferable that Y has such group particularly because a cured body is excellent in heat resistance, mechanical properties and electrical properties.

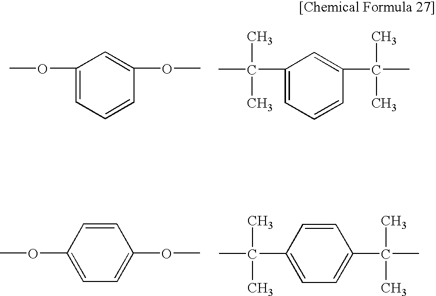

Compared with those having other groups [for example, Bisphenol A-BAPP (=2,2-bis[4-(4-aminophenoxy)phenyl]propane) (2 nuclei+4 nuclei), a thermosetting resin having a dihydrobenzoxazine ring structure with at least one group selected from the above group is excellent in the following:

(1) Compared with a di nuclear-tetra nuclear body, it becomes 3 nuclei-3 nuclei or 3 nuclei-4 nuclei, and thus a minimum spacing between benzoxazine rings is as long as 3 nuclei to increase flexibility.

(2) Regarding a multi-functional phenol having at least 3 functional groups (OH), a bifunctional one easily forms a benzoxazine resin in a linear type and the gelation thereof is difficult to make the synthesis easy.

(3) Comparing Bisphenol P of para-form and Bisphenol M of meta-form, a dielectric constant tends to be lower although it is not clear whether this is due to the low densification by a size of free volume or not. It is easily solvated and thus to have high solubility with respect to an organic solvent, which may be due to the large molecular volume.

It is preferable that Y contains at least 2 benzene rings particularly from the aspects of heat resistance, mechanical properties and electrical properties of a cured body.

Specific examples for Y containing at least 2 benzene rings may include at least one group selected from the group of the following formulae and bonded at a meta-position or para-position with respect to each NH₂ group in the benzene rings of both sides of Y, and the like. It is preferable that Y has such group particularly because a cured body is excellent in heat resistance, mechanical properties and electrical properties.

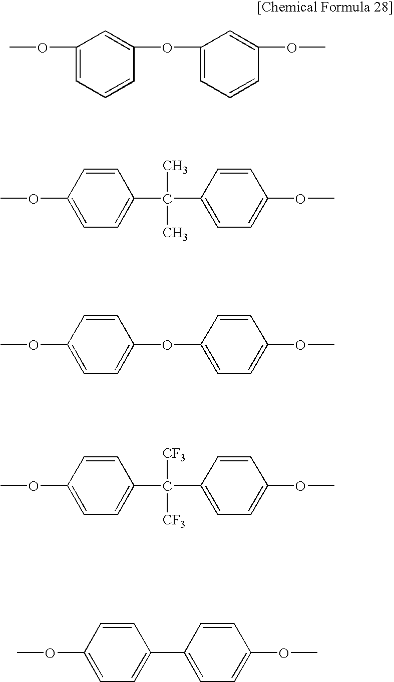

Specific examples for said diamine compound as such ingredient b) may include 1,3-bis(3-aminophenoxy)benzene, 1,3-bis(4-aminophenoxy)benzene, 1,4-bis(3-aminophenoxy)benzene, 1,4-bis(4-aminophenoxy)benzene, 1,3-bis(4-aminophenoxy)neopentane, 2,2-bis[4-(3-aminophenoxy)phenyl]propane, 2,2-bis[4-(4-aminophenoxy)phenyl]propane, bis[(3-aminophenoxy)phenyl]biphenyl, bis[(4-aminophenoxy)phenyl]biphenyl, 2,2-bis[4-(4-aminophenoxy)phenyl]hexafluoropropane, bis[3-(3-aminophenoxy)phenyl]ether, bis[3-(4-aminophenoxy)phenyl]ether, bis[4-(3-aminophenoxy)phenyl]ether, bis[4-(4-aminophenoxy)phenyl]ether, and the like. These diamine compounds are used individually or in a combination of two or more thereof.

As an aldehyde compound of the ingredient c) used in the present invention, which is not particularly limited, formaldehyde is preferred and the formaldehyde can be used as paraformaldehyde which is a polymer thereof or as formalin which is in a form of an aqueous solution thereof. The use of paraformaldehyde makes a reaction proceed mildly. As other aldehyde compounds, acetaldehyde, propionaldehyde, butylaldehyde and the like can be used.

As another embodiment for the producing method according to the present invention, it is preferably provided a method using a mono-functional phenolic compound as the ingredient d) represented by the following general formula (III) in addition to the aforementioned ingredient a) to c). The use of the mono-functional phenolic compound of this ingredient d) can assure workability such as solubility and the like.

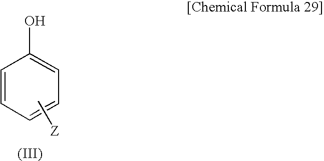

wherein Z is an organic group having 4 or more carbon atoms which optionally has N, O, F as a heteroatom.

The mono-functional phenolic compounds of this ingredient d) have a large side-chain molecular weight and Z in the general formula (III) is an organic group having 4 or more, preferably 6 or more, more preferably 8 to 20 carbon atoms. As the number of carbon atom increases, the free volume becomes larger and thus a dielectric constant is decreased in cases. Z may have N, O, F as a heteroatom.

In the mono-functional phenolic compounds represented by the above general formula (III), the substituent Z is bonded at a para-position with respect is to —OH group and is preferably a group represented by the following formula:

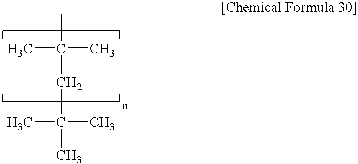

wherein n represents an integer of from 0 to 10.

Among those, Z is preferably a group bonded at a para-position with respect to —OH group and represented by the following formula:

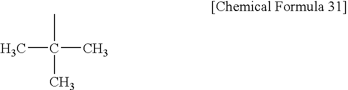

Moreover, said Z is preferably a group bonded mainly at a para-position with respect to —OH group in the benzene ring in the above general formula (III) and represented by the following formula from the aspects of non-volatility at a high temperature and dielectric properties such as a dielectric constant, a dielectric tangent and the like:

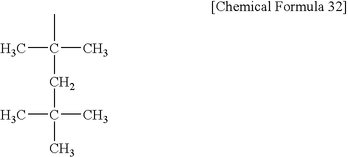

Furthermore, the substituent Z in the mono-functional phenolic compounds represented by the above general formula (III) is a group represented by the following formula and preferably a group bonded at a para-position with respect to —OH group in the benzene ring in the above general formula (III) from the points of non-volatility at a high temperature and dielectric properties such as a dielectric constant, a dielectric tangent and the like:

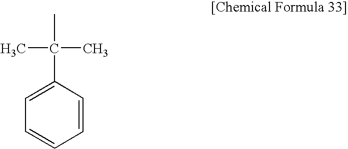

Specific examples for the above mono-functional phenolic compounds of such ingredient d) may include, 2-cyclohexylphenol, 4-cyclohexylphenol, 2-phenylphenol, 4-phenylphenol, 2-benzylphenol, 4-benzylphenol, 2-hydroxybenzophenone, 4-hydroxybenzophenone, 4-hydroxybenzoic acid phenyl ester, 4-phenoxyphenol, 3-benzyloxyphenol, 4-benzyloxyphenol, 4-(1,1,3,3-tetramethylbutyl)phenol, 4-α-cumylphenol, 4-adamantylphenol, 4-triphenylmethylphenol, and the like. These mono-functional phenolic compounds are used individually or in a combination of two or more thereof.

In the production method according to the present invention, the above ingredients a), (b) and c) optionally with the ingredient d) can be reacted by heating those in a proper solvent.

In the production method according to the present invention, a mono-functional or multi-functional phenolic compound can be further added. As said mono-functional phenolic compound which can be further added, the mono-functional phenolic compounds and the like as described above may be mentioned, and as said multi-functional phenolic compound which can be further added, the multi-functional phenolic compounds as described above or 4,4′-biphenol, 2,2′-biphenol, 4,4′-dihydroxydiphenylether, 2,2′-dihydroxydiphenylether, 4,4′-dihydroxydiphenylmethane, 2,2′-dihydroxydiphenylmethane, 2,2-bis(4-hydroxyphenyl)propane, 4,4′-dihydroxybenzophenone, 1,1-bis(4-hydroxyphenyl)ethane, 1,1-bis(4-hydroxyphenyl)propane, 1,1-bis(4-hydroxyphenyl)butane, 2,2-bis(4-hydroxyphenyl)butane, 1,1-bis(4-hydroxyphenyl)-2-methylpropane, 1,1-bis(4-hydroxyphenyl)cyclohexane, 1,1-bis(4-hydroxyphenyl)cyclopentane, 1,1-bis(4-hydroxyphenyl)-1-phenyl ethane, bis(4-hydroxyphenyl)phenylmethane, 9,9-bis(4-hydroxyphenyl)fluorene, 2,2-bis(4-hydroxyphenyl)hexafluoropropane, 1,3-bis(4-hydroxyphenoxy)benzene, 1,4-bis(3-hydroxyphenoxy)benzene, 2,6-bis((2-hydroxyphenyl)methyl)phenol and the like may be mentioned.

A solvent used in the producing method according to the present invention, which is not particularly limited, is preferably what has a good solubility for the phenolic compounds and the diamine compounds as a raw material and a polymer as a product to easily obtain a high degree of polymerization. As such solvent, for example, an aromatic solvent such as toluene, xylene and the like, a halogenic solvent such as chloroform, dichloromethane and the like, an ether solvent such as THF, dioxane and the like may be mentioned.

A reaction temperature and a reaction time are not particularly limited, and a reaction is generally carried out about at a temperature of from room temperature to 120° C. about for from 10 min to 24 hours. In the present invention, it is preferable to carry out a reaction at 30 to 110° C. for from 20 min to 9 hours, which proceeds the reaction to a polymer to manifest a function as a thermosetting resin according to the present invention. Considering that a resin having a molecular weight higher than purposed or a 3-dimensionally grafted polymer is obtained and gelled from a reaction at a high temperature for a long time, it is preferable to make a reaction temperature low or a reaction time short, and considering that it is not possible to synthesize a resin having a molecular weight sufficiently high to be proper for coating from a reaction at a low reaction temperature for a short time, it is preferable to make a reaction temperature high or a reaction time long.

It is an efficient way of proceeding a reaction to remove water produced during a reaction out of the system. After the reaction, for example, a fresh solvent such as a large amount of methanol and the like is added to precipitate a polymer which is separated and dried to obtain a purposed polymer.

In addition, a mono-functional amine compound or a tri-functional amine compound, or other diamine compounds can be used as long as properties of a thermosetting resin according to the present invention are not damaged. The use of a mono-functional amine compound can control a degree of polymerization, the use of a tri-functional amine compound can produce a polymer which is branched. A combination with other diamine compounds can control properties. These can be used simultaneously with the essential diamine compounds in the present invention, or can be added to the system later to be reacted considering the order of a reaction.

[Thermosetting Resin]

A thermosetting resin according to the present invention contains a structure represented by the following general formula (IV). The thermosetting resin according to the present invention can be obtained by the aforementioned method for producing a thermosetting resin.

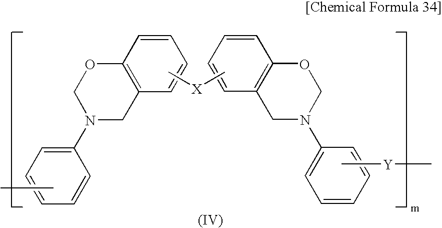

wherein X is an organic group containing an aromatic ring and having 6 or more carbon atoms, which optionally has N, O, F as a heteroatom, provided that the benzene rings of both sides of X are bonded to different atoms in X; Y is an organic group having 5 or more carbon atoms which optionally has N, O, F as a heteroatom, provided that the benzene rings of both sides of Y are bonded to different atoms in Y; and m represents an integer of from 1 to 50.

Said structure can be characterized by IR, NMR, GC-MS, and other means. When m is at least 2, all X's in the synthesized thermosetting resins cannot be the same and can be different. Also, when m is at least 2, all Y's in the synthesized thermosetting resins cannot be the same and can be different.

In the above general formula (IV), it is preferable that X has a structure of one of the following X: group, and Y has a structure of one of the following Y: group:

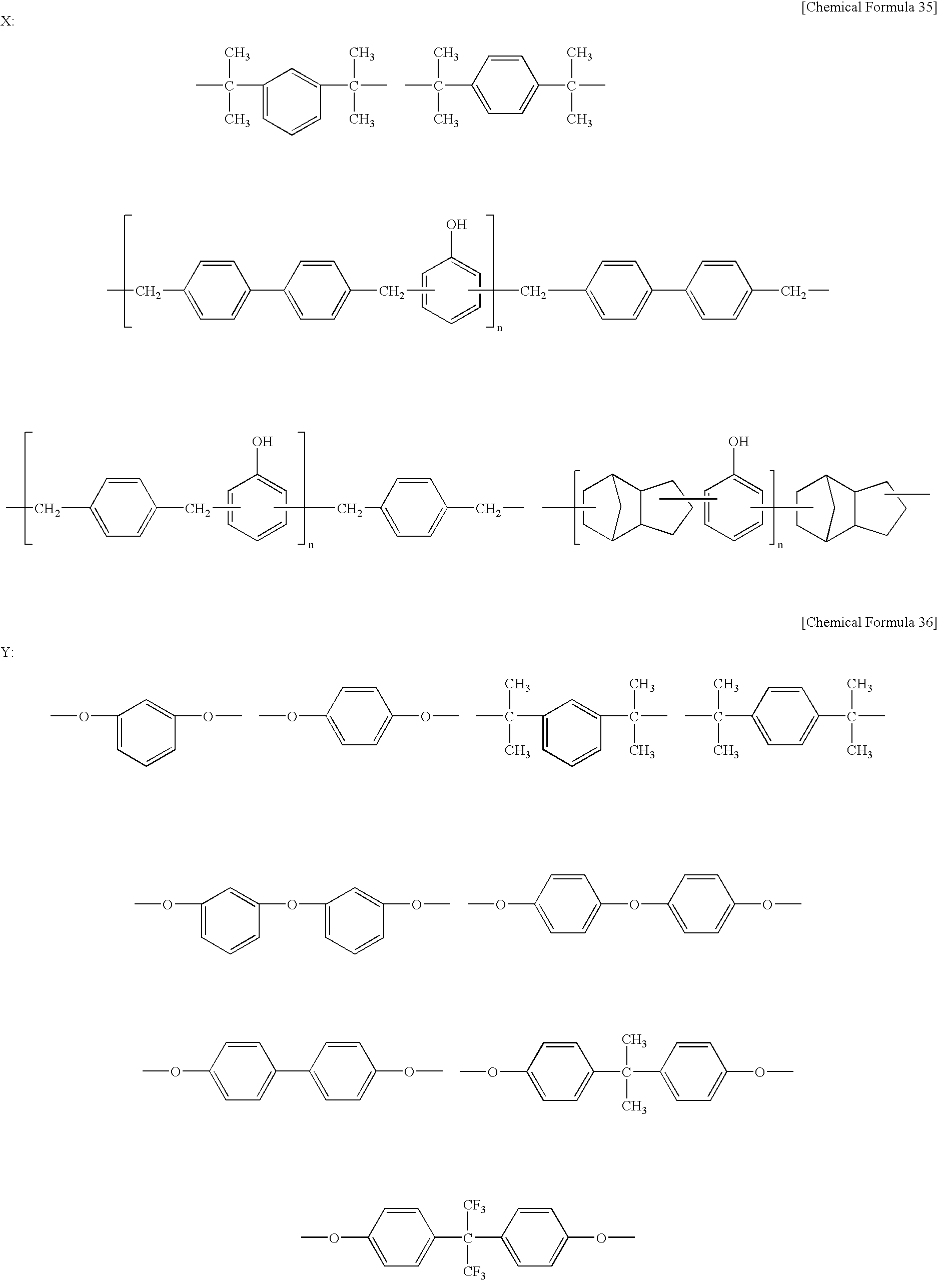

A thermosetting resin according to the present invention has properties being excellent in heat resistance, good in electrical properties and greatly improved in brittleness.

[Thermosefting Composition]

A thermosetting composition according to the present invention contains at least the aforementioned thermosetting resin. The thermosetting composition according to the present invention may include ones containing the aforementioned thermosetting resin preferably as a major component, for example, ones containing the aforementioned thermosetting resin as a major component and other thermosetting resins as a minor component.

As the other thermosetting resins as a minor component, for example, are preferred an epoxy resin, a thermosetting modified polyphenylene ether resin, a thermosetting polyimide resin, a silicone resin, a melamine resin, an urea resin, an allyl resin, a phenol resin, an unsaturated polyester resin, a bismaleimide resin, an alkyd resin, a furan resin, a polyurethane resin, an aniline resin and the like. Among these, an epoxy resin, a phenol resin and a thermosetting polyimide resin are more preferable from the aspect of more improving heat resistance of a molded body formed from this composition. These other thermosetting resins can be used individually or in a combination of two or more thereof. In the thermosetting composition according to the present invention, it is preferable to use a compound preferably having at least one, preferably at least two dihydrobenzoxazine rings within its molecule disclosed in published documents, as the minor component. Said compound having at least one dihydrobenzoxazine ring within its molecule can be used individually or in a combination of two or more thereof.

Further, the thermosetting composition according to the present invention can contain various additives such as a flame retardant, a nucleating agent, an antioxidant (an anti-aging agent), a heat stabilizer, a photo stabilizer, an UV-absorbent, a lubricant, a flame retardant aid, an antistatic agents, an antifogging agent, a filler, a softening agent, a plasticizer, a colorant and the like. These can be used individually or in a combination of two or more thereof. In addition, a reactive or inert solvent can be used upon preparing the thermosetting composition according to the present invention.

The thermosetting resin or thermosetting composition according to the present invention can be made in a form of film by dissolving in an organic solvent, casting and drying to remove the solvent. The thermosetting resin or thermosetting composition according to the present invention is preferable to have a high solubility in an organic solvent such as toluene and the like. This provides an advantage that a solvent amount can be reduced when a film is formed by casting a prepared solution and also provides an additional advantage that if a solvent content is low, energy for evaporating a solvent is small, a time for drying a solvent is short and there is no blistering due to rapid drying.

[Molded Body]

A molded body according to the present invention is obtained by semi-curing or without curing the above-mentioned thermosetting resin or thermosetting composition containing the same.

Herein, “semi-curing” refers to the state in which the curing is stopped in the middle of time and thus further curing is possible. A semi-cured thermosetting resin can be called B-stage (also the same meaning in the description hereinafter). As a molded body according to the present invention, a size or form thereof is not particularly limited because the above-mentioned thermosetting resin has a moldabilty even before curing, and for example, a sheet form (a plate form), a block form and the like can be mentioned, which can further have other parts (for example, an adhesive layer). In addition, ones in a form of sheet can be formed on a substrate film.

[Cured Body]

A cured body according to the present invention is obtained by curing the above thermosetting resin having thermosetting property, the above composition having thermosetting property or the above-mentioned molded body having thermosetting property upon heating. As a curing method, any curing methods in the prior art can be used, in which heating is generally carried out at about 120 to 300° C. for several hours, however, if a heating temperature is relatively low or a heating time is insufficient, the curing becomes insufficient in cases and thus mechanical properties happen to be insufficient. If a heating temperature is too high or a heating time is too long, side reactions such as decomposition and the like occur in cases and thus mechanical properties happen to be decreased unexpectedly. Therefore, it is preferable to choose optimum conditions according to properties of the thermosetting compounds in use.

When the curing is carried out, a proper curing accelerant can be added. As this curing accelerant, any curing accelerant generally used in a ring-opening polymerization of a dihydrobenzoxazine compound can be used, and, for example, there are mentioned multi-functional phenols such as catechol, bisphenol A and the like, sulfonic acids such as p-toluene sulfonic acid, p-phenol sulfonic acid and the like, carbonic acids such as benzoic acid, salicylic acid, oxalic acid, adiphic acid and the like, metal complexes such as cobalt (II) acetylacetonate, aluminum (III) acetylacetonate, zirconium (IV) acetylacetonate and the like, metal oxides such as calcium oxide, cobalt oxide, magnesium oxide, iron oxide and the like, calcium hydroxide, tertiary amines and their salts such as imidazoles and their derivatives, diazabicycloundecene, diazabicyclononene and the like, phosphorous compounds and their derivatives such as triphenylpohosphines, triphenylpohosphine.benzoquinone derivatives, triphenylphosphine.triphenylboron salts, tetraphenylphosphonium.tetraphenylborate and the like. These can be used individually or in a mixture of two or more thereof.

An amount of the curing accelerant is not particularly limited, however, if the added amount is excess, there are cases that a dielectric constant or dielectric tangent of the molded body become worse or mechanical properties thereof can be damaged, and thus it is generally preferred to use the curing accelerant in a ratio of preferably 5 parts by weight or less, more preferably 3 parts by weight or less with respect to 100 parts by weight of the above thermosetting resin.

As mentioned above, the cured body obtained from the above thermosetting resin or thermosetting composition has a benzoxazine structure within the polymer structure and thus it can manifest excellent dielectric properties.

In addition, because the cured body according to the present invention is excellent in reliability, anti-flammability, moldability and the like and has high glass transition temperature (Tg) based on the thermosetting property of the above thermosetting resin or thermosetting composition, it can be applied to parts where stress is imparted or operating parts, and volatile byproducts are not produced upon polymerization and thus such volatile byproducts are not remained in the molded body, which is preferable from the aspect of sanitary management.

The cured body according to the present invention can be applied for the uses such as electronic elements electronic devices and materials thereof, particularly, multilayered substrates, copper-coated laminates, a sealant, an adhesive and the like where excellent dielectric properties are required. Hereinabove, “electronic elements” refers to substrates such as a flexible substrate equipped with probes for electrical connection where an electrical conducting layer is provided on a surface of the cured body according to the present invention, or substrates equipped with IC elements, resistors, condensers and coils.

Hereinafter, representative Examples in the present invention will be shown, but the present invention is not limited thereto.

### EXAMPLE 1

α,α′-bis(4-Hydroxyphenyl)-1,4-diisopropylbenzene (produced by TOKYO CHEMICAL INDUSTRY CO., LTD., 98%) 21.21 g (0.06 mol), 2,2-bis[4-(4-aminophenoxy)phenyl]propane (produced by TOKYO CHEMICAL INDUSTRY CO., LTD., 98%) 25.13 g (0.06 mol) and paraformaldehyde (produced by Wako Pure Chemical Industries, Ltd., 94%) 8.05 g (0.25 mol) were added in chloroform and reacted for 6 hours under reflux with removing produced moistures. The reaction scheme is represented hereinafter. The solution after the reaction was poured into an excess amount of methanol to precipitate the product. Then, the product was separated by filtration and rinsed with methanol. The rinsed product was dried under a reduced pressure to obtain 40.78 g of a thermosetting resin containing a benzoxazine compound of the following structure as a major component.

The measurement of molecular weight was carried out using GPC (gel permeation chromatography) with the constituting system of Degussa DGU-12A, pump LC-10AD, Controller SCL-10A, Detector (RI)RID-10A, and Column oven CTO-1 OAS. The measurement was performed using only two directly-connected KF-804L (exclusion limit 400,000) by SHODEX as a column and THF as a solvent at a flow rate of 1 ml/min and a column temperature of 40° C. Using each of the standard polystyrene (by Toso Corp.) 354000, 189000, 98900, 37200, 17100, 9830, 5870, 2500, 1050 and 500, a 3-dimensional calibration equation was obtained. Based on the calibration equation, the molecular weight of the produced resin was measured. From the measurement of the molecular weight of the obtained resin, the weight-average molecular weight was 19,500.

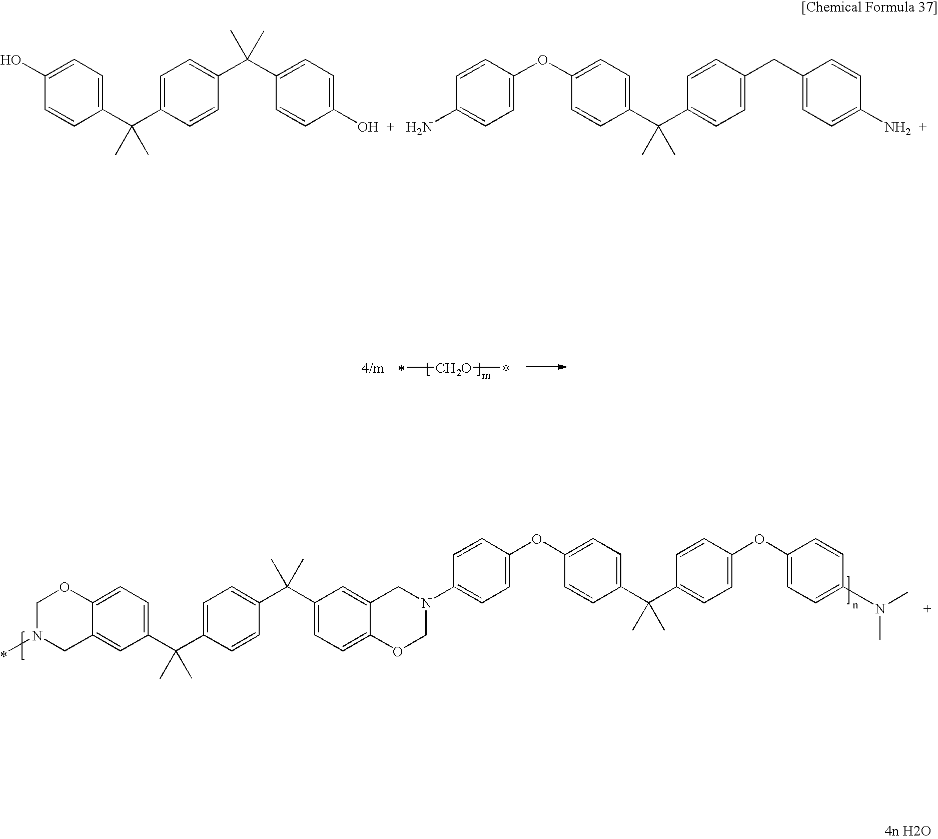

### EXAMPLE 2

The polymer obtained in EXAMPLE 1 was maintained at 180° C. for 1 hour by a thermal press process to obtain a cured body in a form of sheet of 0.5 mmt. The obtained sheet was brownish, transparent, homogeneous and excellent in flexibility. For the obtained cured body, a dielectric constant and a dielectric tangent were measured at 100 MHz and 1 GHz, at 23° C. using a dielectric constant measuring instrument (a product name “RF Impedance/Material analyzer E4991A”, by Agilent Technologies) by a capacitance method. The results are shown in Table 1. The cured body of EXAMPLE 2 showed good properties all in its dielectric constant and dielectric tangent.

The obtained sheet was precisely cut to shape and then a 5% weight reduction temperature (Td 5) was evaluated at a temperature raising rate of 10 (C/min under air environment by a TGA method using the product name “DTG-60” by Shimazu Corporation. The cured body of EXAMPLE 2 showed a good value wherein Td5 was 415° C.

TABLE 1
EXAMPLE 2

| | 100 MHz | | 1 GHz | | |
|---|---|---|---|---|---|
| | dielectric | dielectric | dielectric | dielectric | |
| | constant | tangent | constant | tangent | Td5 |
| EXAMPLE 1 | 3.01 | 0.0053 | 2.98 | 0.0040 | 415° C. |

### EXAMPLE 3

A thermosetting resin was produced in the same manner as in EXAMPLE 1 with the exception that α,α′-bis(4-hydroxyphenyl)-1,4-diisopropylbenzene was instead changed to bisphenol M (produced by Mitsui Chemical Co. Ltd.) 21.21 g (0.06 mol). The produced amount was 40.56 g. From the measurement of the molecular weight of the obtained resin by GPC, the weight-average molecular weight was 10,600.

### EXAMPLE 4

The resin obtained in EXAMPLE 3 was evaluated in the same manner as in EXAMPLE 2. The results are summarized and shown in Table 2. The thermosetting resin in EXAMPLE 3 showed good results all in electrical properties and heat resistance

TABLE 2
EXAMPLE 4

| | 100 MHz | | 1 GHz | | |
|---|---|---|---|---|---|
| | dielectric | dielectric | dielectric | dielectric | |
| | constant | tangent | constant | tangent | Td5 |
| EXAMPLE 3 | 3.06 | 0.0036 | 3.04 | 0.0051 | 420° C. |

### EXAMPLE 5

α,α′-bis(4-Hydroxyphenyl)-1,4-diisopropylbenzene (produced by TOKYO CHEMICAL INDUSTRY CO., LTD., 98%) 20.68 g (0.0585 mol), 4-(-cumylphenol (produced by TOKYO CHEMICAL INDUSTRY CO., LTD., 98%) 2.82 g (0.013 mol), α,α′-bis(4-amino phenyl)-1,4-diisopropylbenzene (produced by TOKYO CHEMICAL INDUSTRY CO., LTD., 98%) 22.85 g (0.065 mol), and paraformaldehyde (produced by Wako Pure Chemical Industries, Ltd., 94%) 8.72 g (0.27 mol) were added in chloroform and reacted for 6 hours under reflux with removing produced moistures. The solution after the reaction was poured into an excess amount of methanol to precipitate the product. Then, the product was separated by filtration and rinsed with methanol. The rinsed product was dried under a reduced pressure to obtain 37.21 g of a thermosetting resin containing a benzoxazine compound of the following structure as a major component.

From the measurement of the molecular weight of the obtained resin by GPC, the weight-average molecular weight was 7,200.

### EXAMPLE 6

The resin obtained in EXAMPLE 5 was evaluated in the same manner as in EXAMPLE 2. The results are summarized and shown in Table 3. The thermosetting resin in EXAMPLE 3 showed good results all in electrical properties and heat resistance.

TABLE 3
EXAMPLE 6

| | 100 MHz | | 1 GHz | | |
|---|---|---|---|---|---|
| | dielectric | dielectric | dielectric | dielectric | |
| | constant | tangent | constant | tangent | Td5 |
| EXAMPLE 5 | 2.92 | 0.0051 | 2.90 | 0.0065 | 406° C. |

### EXAMPLE 7

Biphenyl novolac phenol resin (produced by Meiwa Chemical Industry Co., Ltd., “MEH7851SS”, OH equivalent 204) 30.00 g, α,α′-bis(4-aminophenyl)-1,4-diisopropylbenzene (produced by TOKYO CHEMICAL INDUSTRY CO., LTD., 98%) 21.08 g (0.061 mol), and paraformaldehyde (produced by Wako Pure Chemical Industries, Ltd., 94%) 8.13 g (0.25 mol) were added in chloroform and reacted for 6 hours under reflux with removing produced moistures. The solution after the reaction was poured into an excess amount of methanol to precipitate the product. Then, the product was separated by filtration and rinsed with methanol. The rinsed product was dried under a reduced pressure to obtain 45.52 g of a thermosetting resin having a benzoxazine structure.

### EXAMPLE 8

A thermosetting resin having a benzoxazine structure was produced in the same manner as in EXAMPLE 7 with the exception that α,α′-bis(4-aminophenyl)-1,4-diisopropylbenzene (produced by TOKYO CHEMICAL INDUSTRY CO., LTD., 98%) was instead changed to 2,2-bis[4-(4-aminophenoxy)phenyl]propane (produced by Wakayama Seika Co., Ltd., 99.9%) 24.90 g (0.061 mol). The produced amount was 45.80 g.

### EXAMPLE 9

### EXAMPLE 10

The resins obtained in EXAMPLE 7 and 8 were evaluated in the same manner as in EXAMPLE 2. The results are summarized and shown in Table 4. The thermosetting resins in EXAMPLE 9 and 10 showed good results all in electrical properties and heat resistance.

TABLE 4
EXAMPLES 9 and 10

| | | 100 MHz | | 1 GHz | | |
|---|---|---|---|---|---|---|
| | Used | dielectric | dielectric | dielectric | dielectric | |
| | polymer | constant | tangent | constant | tangent | Td5 |
| EXAMPLE 7 | EXAMPLE 7 | 3.02 | 0.0035 | 3.00 | 0.0062 | 450° C. |
| EXAMPLE 8 | EXAMPLE 8 | 3.14 | 0.0020 | 3.14 | 0.0070 | 473° C. |

### EXAMPLE 11

Bisphenol M (produced by Mitsui Chemical Co. Ltd., 99.5%) 27.86 g (0.08 mol), bisaniline M (produced by Mitsui Chemical Co. Ltd., 99.98%) 27.57 g (0.08 mol), and paraformaldehyde (produced by Wako Pure Chemical Industries, Ltd., 94%) 10.73 g (0.34 mol) were added in chloroform and reacted for 6 hours under reflux with removing produced moistures. The solution after the reaction was poured into an excess amount of methanol to precipitate the product. Then, the product was separated by filtration and rinsed with methanol. The rinsed product was dried under a reduced pressure to obtain 31.21 g of a thermosetting resin having a benzoxazine compound of the following structure as major component. From the measurement of the molecular weight of the obtained resin by GPC, the weight-average molecular weight was 16,600.

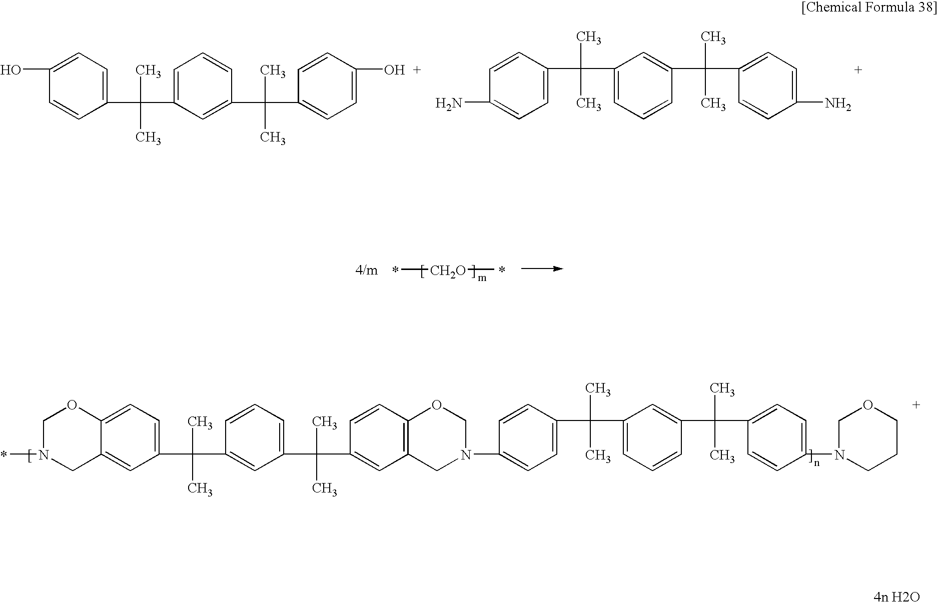

### EXAMPLE 12

The resin obtained in EXAMPLE 11 was evaluated in the same manner as in EXAMPLE 2. The results are summarized and shown in Table 5. The thermosetting resin in EXAMPLE 11 showed good results all in electrical properties and heat resistance.

TABLE 5
EXAMPLE 12

| | 100 MHz | | 1 GHz | | |
|---|---|---|---|---|---|
| | dielectric | dielectric | dielectric | dielectric | |
| | constant | tangent | constant | tangent | Td5 |
| EXAMPLE 11 | 2.95 | 0.0034 | 2.94 | 0.0039 | 421° C. |

### EXAMPLE 13

DPP6085 (produced by Nippon Oil Co., Ltd., 99%) 30.0 g (0.086 mol), bisaniline P (produced by Mitsui Chemical Co. Ltd., 99%) 29.91 g (0.086 mol) were added in chloroform and stirred, then, paraformaldehyde (produced by Wako Pure Chemical Industries, Ltd., 94%) 11.53 g (0.344 mol) was further added and reacted for 6 hours under reflux with removing produced moistures. The solution after the reaction was poured into an excess amount of methanol to precipitate the product. Then, the product was separated by filtration and rinsed with methanol. The rinsed product was dried under a reduced pressure to obtain 36.27 g of a thermosetting resin having a benzoxazine compound of the following structure as a major component.

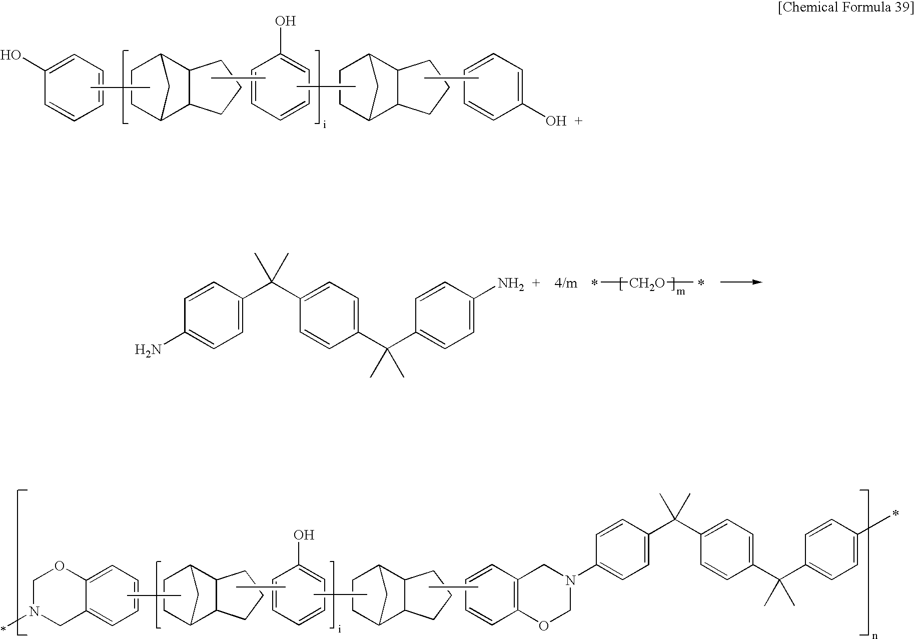

### EXAMPLE 14

The resin obtained in EXAMPLE 13 was evaluated in the same manner as in EXAMPLE 2. The results are summarized and shown in Table 6. The thermosetting resin in EXAMPLE 13 showed good electrical properties.

TABLE 6
EXAMPLE 14

| | 100 MHz | | 1 GHz | | |
|---|---|---|---|---|---|
| | dielectric | dielectric | dielectric | dielectric | |
| | constant | tangent | constant | tangent | Td5 |
| EXAMPLE 13 | 3.04 | 0.005 | 3.01 | 0.007 | 424° C. |

### EXAMPLE 15

α,α′-bis(4-Hydroxyphenyl)-1,4-diisopropylbenzene (produced by TOKYO CHEMICAL INDUSTRY CO., LTD., 98%) 20.68 g (0.0585 mol), 4-t-octylphenol (produced by TOKYO CHEMICAL INDUSTRY CO., LTD., 95%) 2.82 g (0.013 mol), α,α′-bis(4-aminophenyl)-1,4-diisopropylbenzene (produced by TOKYO CHEMICAL INDUSTRY CO., LTD., 98%) 22.85 g (0.065 mol), and paraformaldehyde (produced by Wako Pure Chemical Industries, Ltd., 94%) 8.72 g (0.27 mol) were added in chloroform and reacted for 6 hours under reflux with removing produced moistures. The solution after the reaction was poured into an excess amount of methanol to precipitate the product. Then, the product was separated by filtration and rinsed with methanol. The rinsed product was dried under a reduced pressure to obtain 41.95 g of a thermosetting resin having a benzoxazine compound of the following structure as major component.

### EXAMPLE 16

The resin obtained in EXAMPLE 15 was evaluated in the same manner as in EXAMPLE 2. The results are summarized and shown in Table 7. The thermosetting resin in EXAMPLE 15 showed good results all in electrical properties and heat resistance.

TABLE 7
EXAMPLE 15

| | 100 MHz | | 1 GHz | | |
|---|---|---|---|---|---|
| | dielectric | dielectric | dielectric | dielectric | |
| | constant | tangent | constant | tangent | Td5 |
| EXAMPLE 15 | 2.94 | 0.004 | 2.92 | 0.004 | 410° C. |

### EXAMPLE 17

α,α′-bis(4-Hydroxyphenyl)-1,4-diisopropylbenzene (produced by TOKYO CHEMICAL INDUSTRY CO., LTD., 98%) 13.85 g (0.040 mol), bisaniline M (produced by TOKYO CHEMICAL INDUSTRY CO., LTD., 98%) 13.78 g (0.040 mol), and paraformaldehyde (produced by Wako Pure Chemical Industries, Ltd., 94%) 5.04 g (0.168 mol) were added in chloroform and reacted for 6 hours under reflux with removing produced moistures. The solution after the reaction was poured into an excess amount of methanol to precipitate the product. Then, the product was separated by filtration and rinsed with methanol. The rinsed product was dried under a reduced pressure to obtain 34.52 g of a thermosetting resin having a benzoxazine compound of the following structure as major component.

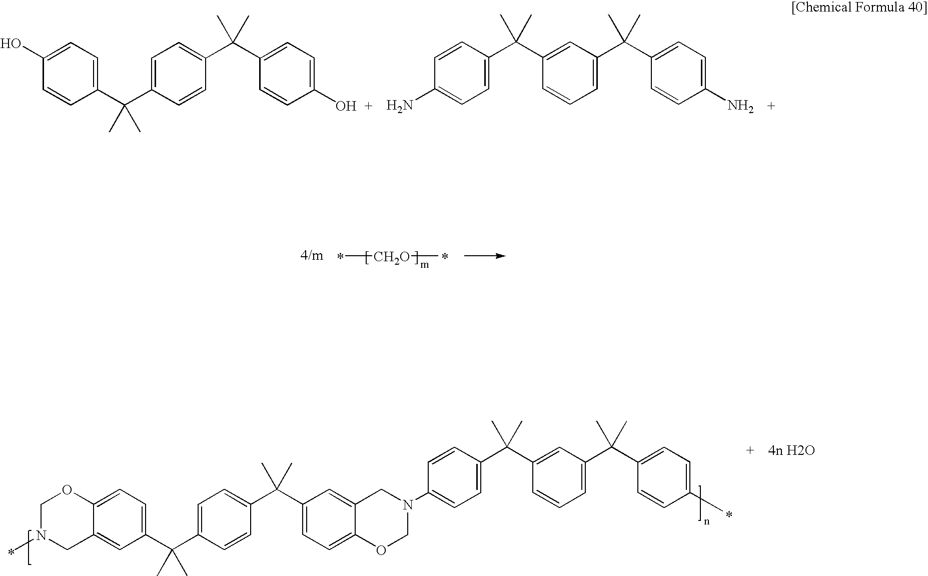

### EXAMPLE 18

The resin obtained in EXAMPLE 17 was evaluated in the same manner as in EXAMPLE 2. The results are summarized and shown in Table 8. The thermosetting resin in EXAMPLE 17 showed good results all in electrical properties and heat resistance.

TABLE 8
EXAMPLE 18

| | 100 MHz | | 1 GHz | | |
|---|---|---|---|---|---|
| | dielectric | dielectric | dielectric | dielectric | |
| | constant | tangent | constant | tangent | Td5 |
| EXAMPLE 17 | 2.95 | 0.003 | 2.93 | 0.004 | 411° C. |

### COMPARATIVE EXAMPLE 1

### Bis-A/MDA (2 Nuclei+2 Nuclei)

Bisphenol A (produced by TOKYO CHEMICAL INDUSTRY CO., LTD., 98%) 18.45 g (0.08 mol), 4,4′-diaminodiphenylmethane ((produced by Wako Pure Chemical Industries, Ltd., 98%) 16.19 g (0.08 mol), paraformaldehyde (produced by Wako Pure Chemical Industries, Ltd., 94%) 10.73 g (0.336 mol) were added in chloroform and reacted for 6 hours under reflux with removing produced moistures. The solution after the reaction was poured into an excess amount of methanol to precipitate the product. Then, the product was separated by filtration and rinsed with methanol. The rinsed product was dried under a reduced pressure to obtain 26.44 g of a thermosetting resin having a benzoxazine compound of the following structure as major component.

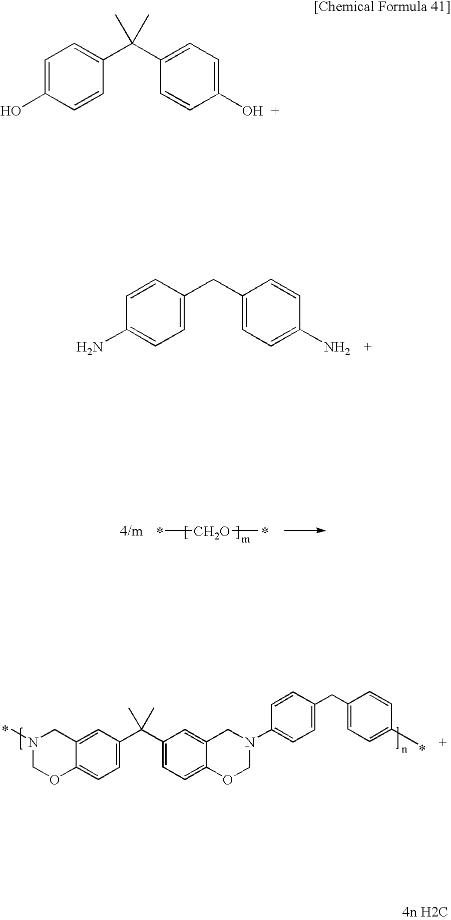

### COMPARATIVE EXAMPLE 2

The resin obtained in COMPARATIVE EXAMPLE 1 was evaluated in the same manner as in EXAMPLE 2. The results are summarized and shown in Table 9. The thermosetting resin in COMPARATIVE EXAMPLE 1 was inferior all in electrical properties and heat resistance.

TABLE 9
COMPARATIVE EXAMPLE 2

| | 100 MHz | | 1 GHz | | |
|---|---|---|---|---|---|
| | dielectric | dielectric | dielectric | dielectric | |
| | constant | tangent | constant | tangent | Td5 |
| COMPAR- | 3.15 | 0.005 | 3.11 | 0.007 | 382° C. |
| ATIVE | | | | | |
| EXAMPLE 1 | | | | | |

### COMPARATIVE EXAMPLE 3

### Bis-A/BAPP(2 Nuclei+4 Nuclei)

Bisphenol A (produced by TOKYO CHEMICAL INDUSTRY CO., LTD., 98%) 18.27 g (0.08 mol), 2,2-bis[4-(4-aminophenoxy)phenyl]propane (produced by TOKYO CHEMICAL INDUSTRY CO., LTD., 98%) 32.89 g (0.08 mol), paraformaldehyde (produced by Wako Pure Chemical Industries, Ltd., 94%) 10.73 g (0.336 mol) were added in chloroform and reacted for 6 hours under reflux with removing produced moistures. The solution after the reaction was poured into an excess amount of methanol to precipitate the product. Then, the product was separated by filtration and rinsed with methanol. The rinsed product was dried under a reduced pressure to obtain 39.62 g of a thermosetting resin having a benzoxazine compound of the following structure as major component.

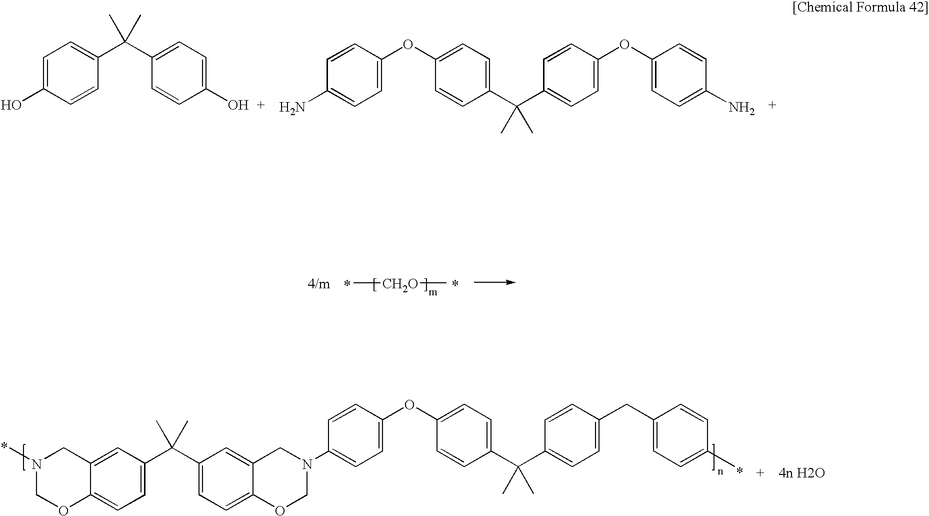

### COMPARATIVE EXAMPLE 4

The resin obtained in COMPARATIVE EXAMPLE 3 was evaluated in the same manner as in EXAMPLE 2. The results are summarized and shown in Table 10. The thermosetting resin in COMPARATIVE EXAMPLE 3 was inferior in electrical properties and heat resistance and thus the film was whitened upon folding.

TABLE 10
COMPARATIVE EXAMPLE 4

| | 100 MHz | | 1 GHz | | |
|---|---|---|---|---|---|
| | dielectric | dielectric | dielectric | dielectric | |
| | constant | tangent | constant | tangent | Td5 |
| COMPAR- | 3.1 | 0.006 | 3.2 | 0.007 | 398° C. |
| ATIVE | | | | | |
| EXAMPLE 3 | | | | | |

### EXAMPLE 19

α,α′-bis(4-Hydroxyphenyl)-1,4-diisopropylbenzene (produced by TOKYO CHEMICAL INDUSTRY CO., LTD., 98%) 22.98 g (0.065 mol), bisaniline P (produced by TOKYO CHEMICAL INDUSTRY CO., LTD., 98%) 22.85 g (0.065 mol), paraformaldehyde (produced by Wako Pure Chemical Industries, Ltd., 94%) 8.72 g (0.273 mol) were added in chloroform and reacted for 6 hours under reflux with removing produced moistures. The solution after the reaction was poured into an excess amount of methanol to precipitate the product. Then, the product was separated by filtration and rinsed with methanol. The rinsed product was dried under a reduced pressure to obtain 34.52 g of a thermosetting resin having a benzoxazine compound of the following structure as major component. The obtained polymer was insoluble in commonly-used solvents such as toluene or DMF. It was not melted even under thermal press and thus not made in a film.

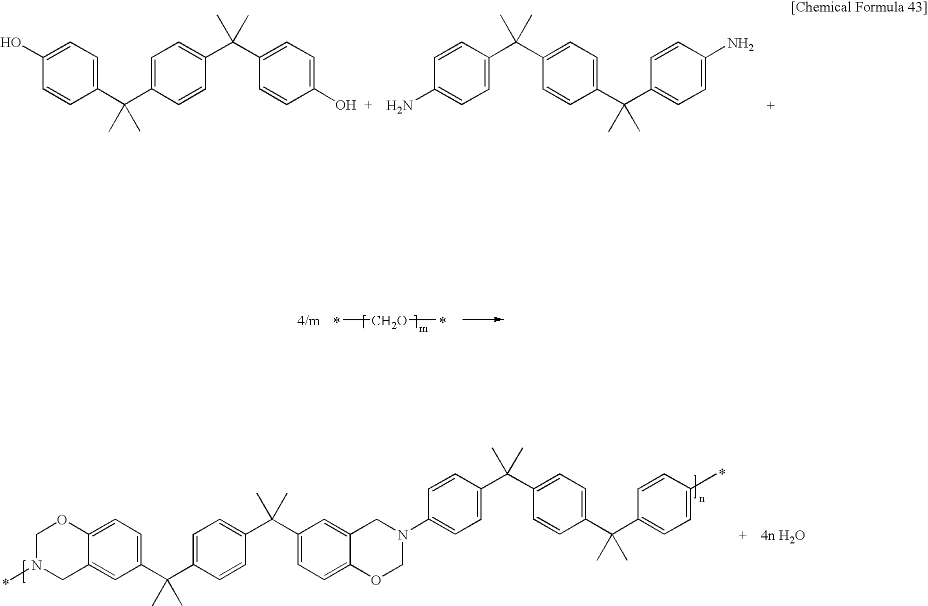

### EXAMPLE 20

Using toluene as a solvent, the benzoxazine resins synthesized in each EXAMPLE were added in the solvent to make solutions of each of 20, 30, 40, 50 and 60 wt % and stirred at room temperature for 24 hours, and then their dissolution was investigated.

The benzoxazine resin in EXAMPLE 13 was dissolved in any solutions of 20 to 50 wt %, the benzoxazine resins in EXAMPLE 1, 3, 5, 7, 8, 11, 15 & 17 and COMPARATIVE EXAMPLE 1 & 3 were dissolved in any solutions of 20 to 60 wt %. The benzoxazine resin in EXAMPLE 19 was not dissolved in any solutions of 20 to 60 wt %.

The use of M-forms such as bisphenol M or bisaniline M having substituents at a meta-position and a curved structure improves solubility even in a high molecular weight.

### EXAMPLE 21

Sample films for the products in EXAMPLE 1, 3, 5, 7, 8, 11, 13, 15 & 17, COMPARATIVE EXAMPLE 1 & 3 were made in a width of 10 mm and a thickness of 75μ. In making the sample films, a 50 wt % solution using each resin and toluene of the same weights was prepared, coated by pulling with an applicator and then dried in an oven to evaporate solvent to obtain the sample films. The above sample films were subject to flexibility test. In the flexibility test, the sample film was folded in two planes and pressed from both sides with a force of 3 kgf, and then the film was unfolded to perform the evaluation of O: the film is transparent with only a scar due to folding, Δ: whitening of the film, X: cracking of the film.

For EXAMPLES 1, 3, 5, 7, 8, 11, 13, 15 and 17, all evaluations were O, for COMPARATIVE EXAMPLE 1, the evaluation was X, and for COMPARATIVE EXAMPLE 3, the evaluation was A.

### INDUSTRIAL APPLICABILITY

The present invention has industrial applicability as a method for producing a thermosetting resin which is excellent in heat resistance, good in electrical properties and greatly improved in brittleness, a thermosetting resin produced by the method, a thermosetting composition containing the same, a molded body thereof, a cured body thereof, and an electronic device containing those.

1. A method for producing a thermosetting resin having a dihydrobenzoxazine ring structure, the method comprising heating and reacting a) a multi-functional phenolic compound represented by the following general formula (I), b) a diamine compound represented by the following general formula (II) and c) an aldehyde compound: 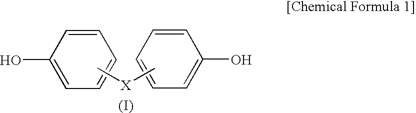
wherein X is an organic group containing an aromatic ring and having 6 or more carbon atoms, which optionally has N, O, F as a heteroatom, provided that the benzene rings of both sides of X are bonded to different atoms in X; 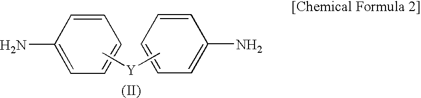
wherein Y is an organic group having 5 or more carbon atoms which optionally has N, O, F as a heteroatom, provided that the benzene rings of both sides of Y are bonded to different atoms in Y.

2. The method for producing a thermosetting resin according to claim 1, wherein X in the general formula (I) is bonded at a para-position with respect to each —OH group in the benzene rings of both sides of X and the structure of X is any of the following structures:

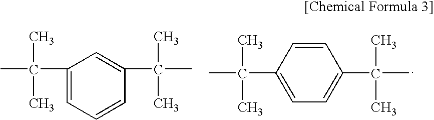

3. The method for producing a thermosetting resin according to claim 1, wherein X in the general formula (I) is a structure represented by the following formula: 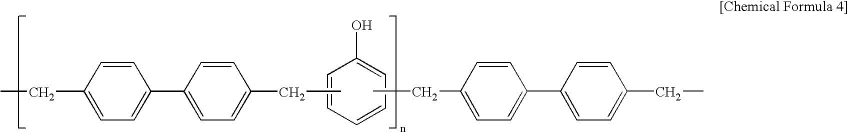
wherein n represents an integer of from 0 to 10.

4. The method for producing a thermosetting resin according to claim 1, wherein X in the general formula (I) is a structure of the following formula: 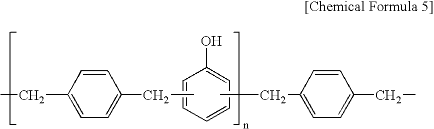
wherein n represents an integer of from 0 to 10.

5. The method for producing a thermosetting resin according to claim 1 wherein X in the general formula (I) is a structure represented by the following formula: 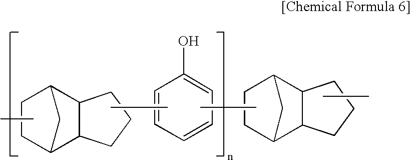
wherein n represents an integer of from 0 to 10.

6. The method for producing a thermosetting resin having a dihydrobenzoxazine ring structure according to claim 1, the method comprising heating and reacting a) a multi-functional phenolic compound represented by the following general formula (I), b) a diamine compound represented by the following general formula (II), c) an aldehyde compound and d) a mono-functional phenolic compound represented by the following general formula (III): 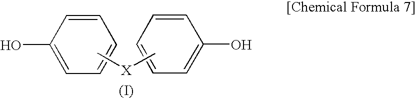
wherein X is an organic group containing an aromatic ring and having 6 or more carbon atoms, which optionally has N, O, F as a heteroatom, provided that the benzene rings of both sides of X are bonded to different atoms in X; 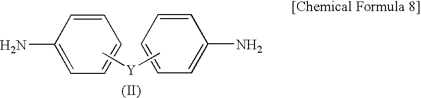
wherein Y is an organic group having 5 or more carbon atoms which optionally has N, O, F as a heteroatom, provided that the benzene rings of both sides of Y are bonded to different atoms in Y: 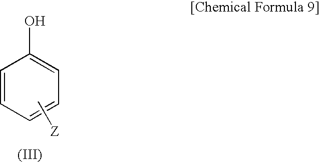
wherein Z is an organic group having 4 or more carbon atoms which optionally has N, O, F as a heteroatom.

7. The method for producing a thermosetting resin according to claim 6 wherein the substituent Z in the mono-functional phenolic compound represented by the general formula (III) is bonded at a para-position with respect to —OH group and is a group represented by the following formula: 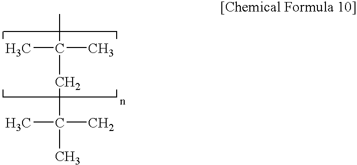
wherein n represents an integer of from 0 to 10.

8. The method for producing a thermosetting resin according to claim 6, wherein the substituent Z in the mono-functional phenolic compound represented by the general formula (III) is bonded at a para-position with respect to —OH group and is a group represented by the following formula:

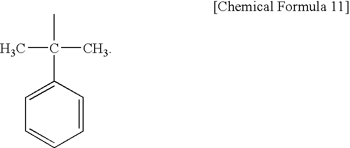

9. The method for producing a thermosetting resin according to claim 1, wherein Y in the general formula (II) is a group represented by the following formula:

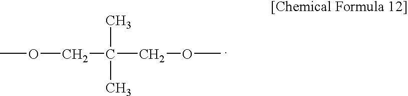

10. The method for producing a thermosetting resin according to claim 1, wherein Y in the general formula (II) contains one benzene ring.

11. The method for producing a thermosetting resin according to claim 10, wherein Y in the general formula (II) is at least one group selected from the group consisting of the following formulae and is bonded at a meta-position or para-position with respect to each NH₂ group in the benzene rings bonded to both sides of Y:

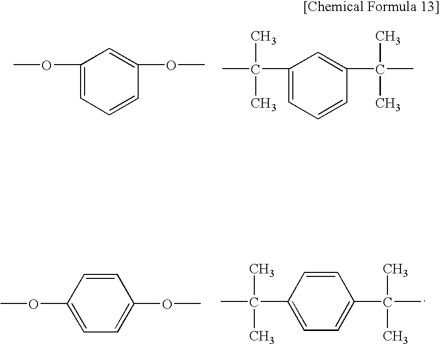

12. The method for producing a thermosetting resin according to claim 1, wherein Y in the general formula (II) contains at least 2 benzene rings.

13. The method for producing a thermosetting resin according to claim 12, wherein Y in the general formula (II) is at least one group selected from the groups of the following formula and is bonded at a meta-position or para-position with respect to each NH₂ group in the benzene rings bonded to both sides of Y:

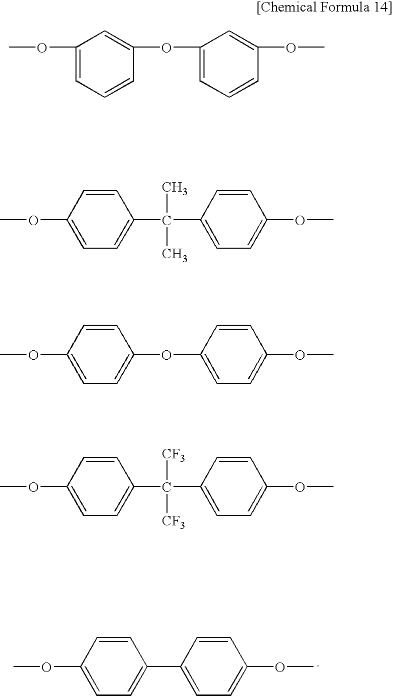

14. A thermosetting resin having a dihydrobenzoxazine structure represented by the following general formula (IV): 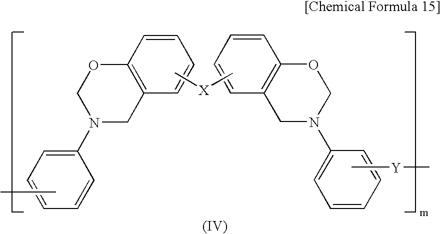
wherein X is an organic group containing an aromatic ring and having 6 or more carbon atoms, which optionally has N, O, F as a heteroatom, provided that the benzene rings of both sides of X are bonded to different atoms in X; Y is an organic group having 5 or more carbon atoms which optionally has N, O, F as a heteroatom, provided that the benzene rings of both sides of Y are bonded to different atoms in Y; and m represents an integer of from 1 to 50.

15. The thermosetting resin according to claim 14, wherein X in the general formula (IV) has a structure of one of the following X: group, and Y in the general formula (IV) has a structure of one of the following Y: group:

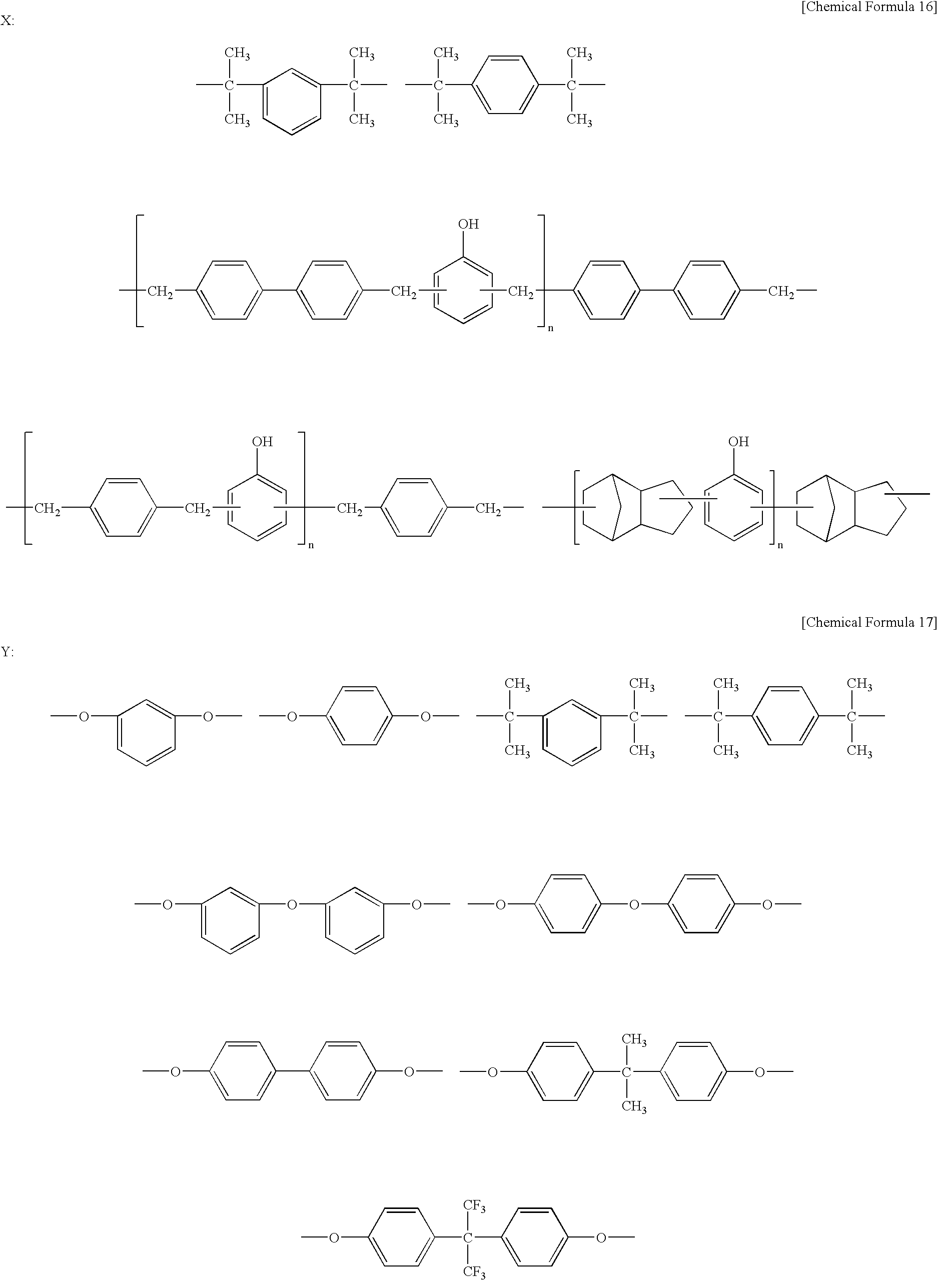

16. A thermosetting composition containing at least the thermosetting resin according to claim 14.

17. A molded body obtained by semi-curing or without curing the thermosetting composition according to claim 16.

18. A cured body obtained from the thermosetting resin according to claim 14.

19. A cured body obtained from the thermosetting composition according to claim 16.

20. An electronic element containing the cured body according to claim 18.

21. A thermosetting resin produced by the method according to claim 1.

22. A thermosetting composition containing at least the thermosetting resin according to claim 21.

23. A molded body obtained by semi-curing or without curing the thermosetting composition according to claim 22.

24. A cured body obtained from the thermosetting resin according to claim 21.

25. A cured body obtained from the thermosetting composition according to claim 22.

26. An electronic element containing the cured body according to claim 24.

27. An electronic element containing the cured body according to claim 19.

28. An electronic element containing the cured body according to claim 25.
